(19) United States
(12) Patent Application Publication
(10) Pub. No.: US 2012/0019819 A1
(43) Pub. Date: Jan. 26, 2012

(54) RAMAN SPECTROSCOPY USING MULTIPLE DISCRETE LIGHT SOURCES

(75) Inventor: Robert G. Messerchmidt, Los Altos, CA (US)

(73) Assignee: Rare Light, Inc., Mountain View, CA (US)

(21) Appl. No.: 13/145,711

(22) PCT Filed: Jan. 20, 2010
(86) PCT No.: PCT/US10/21528

§ 371 Date: Oct. 11, 2011

Related U.S. Application Data
(60) Provisional application No. 61/146,195, filed on Jan. 21, 2009.

(51) Int. Cl. G01J 3/44; G01J 3/45; G01J 3/28; G06F 15/16

(52) U.S. Cl. 356/301; 709/206; 356/451; 356/326

(57) ABSTRACT

Raman spectroscopy apparatuses are described that detect the spectral characteristics of a sample wherein the apparatus consists of a multiplicity of modulated discrete light sources adapted to excite a sample with electromagnetic radiation, a filter adapted to isolate a predetermined wavelength emitted by the sample wherein the wavelength is further modulated at different frequencies, and a detector for detecting the isolated wavelength. The apparatus may further consist of an interferometer, such as a Michelson interferometer, adapted to modulate the excitation energy. Also provided herein are methods, systems, and kits incorporating the Raman spectroscopy apparatus.

### CROSS-REFERENCE

This application claims the benefit of U.S. Provisional Application No. 61/146,195 filed Jan. 21, 2009, which application is incorporated herein by reference.

### FIELD OF THE INVENTION

The disclosure relates to Raman spectroscopy apparatuses that detect the spectral characteristics of a sample wherein the apparatus consists of a multiplicity of modulated discrete light sources adapted to excite a sample with electromagnetic radiation, a filter adapted to isolate a predetermined wavelength emitted by the sample wherein the wavelength is further modulated at different frequencies, and a detector for detecting the isolated wavelength.

### BACKGROUND OF THE INVENTION

In classical Raman spectroscopy, a single laser source excites a sample with an excitation energy. The energy emitted is scattered after contacting the sample. Most of the light scattered by the sample is scattered elastically. This light is at an unshifted wavelength and is detected after leaving the specimen. A small portion of the laser light is scattered inelastically after coming in contact with the sample. This light exits the specimen at shifted wavelengths which are wavelengths at both higher and lower energy states than the original laser wavelength. The amount of the shift is consistent with the vibrational spectrum of the sample under test. The light shifted to longer wavelengths is called the Stokes-shifted Raman signal. The light shifted to shorter wavelength is called the anti-Stokes. The amount of this shifted light is very small, perhaps one part in 10 million or 100 million depending on the sample. For this reason, the power in the excitation light must generally be very high in intensity. In general, Raman spectroscopy is performed with an excitation light source that is usually a laser. The Raman shift spectrum is then detected and analyzed using a spectrometer or spectrograph. A complete spectrum is generally collected.

Other concepts relating to Raman spectroscopy devices and systems are disclosed in, for example, U.S. Pat. No. 7,075,642 to Koo, et al. for Method, structure, and apparatus for Raman spectroscopy; U.S. Pat. No. 6,868,285 to Muller-Dethleffs for Method and device for detecting substances in body fluids by Raman spectroscopy; U.S. Pat. No. 5,786,893 to Fink, et al. for Raman spectrometer; U.S. Pat. No. 7,002,679 to Brady, et al. for Encoded excitation source Raman spectroscopy methods and systems; U.S. Pat. No. 6,867,858 to Owen et al. for Raman spectroscopy crystallization analysis method; U.S. Pat. No. 6,778,269 to Fink et al. for Detecting isotopes and determining isotope ratios using Raman spectroscopy; U.S. Pat. No. 6,744,500 to Bradbury et al. for Identification of material inclusions in pulp and paper using Raman spectroscopy; U.S. Pat. No. 6,667,070 to Adem for Method of in situ monitoring of thickness and composition of deposited films using Raman spectroscopy; U.S. Pat. No. 6,545,755 to Ishihama et al. for Micro-Raman spectroscopy system for identifying foreign material on a semiconductor wafer; U.S. Pat. No. 6,473,174 to Ballast et al. for Resist removal monitoring by Raman spectroscopy; U.S. Pat. No. 6,100,975 to Smith et al. for Raman spectroscopy apparatus and method using external cavity laser for continuous chemical analysis of sample streams; U.S. Pat. No. 5,615,673 to Berger et al. for Apparatus and methods of Raman spectroscopy for analysis of blood gases and analytes.

For many applications of spectroscopy, there is no need to collect a full spectrum. In fact, for industrial monitoring applications and handheld medical devices, it is preferable for an instrument to measure only a handful of wavelengths at the important position for the quantitative or qualitative analysis of the system under test. In the field of infrared absorption spectroscopy, this type of instrument is called a filtometer, and includes a set of discrete filters for measuring only the wavelengths of interest.

### SUMMARY OF THE INVENTION

An aspect of the disclosure is directed toward a Raman spectroscopy device for detecting the spectral characteristics using a multiple modulated discrete energy sources and a single narrow bandpass detector. The device comprises a multiplicity of discrete light sources adapted to excite a sample with electromagnetic radiation; a first set of modulators associated with each discrete light source; a narrow bandpass filter adapted to pass a selected narrow wavelength range to the detector; and a detector for detecting the isolated wavelength.

A method for detecting the spectral characteristics of a sample is also provided. The method comprises the steps of emitting electromagnetic radiation from a multiplicity of modulated discrete light sources; filtering the electromagnetic radiation from the multiplicity of discrete light sources into a series of individual wavelengths; exciting the sample with the series of individual wavelengths of electromagnetic radiation; filtering a signal emitted by the sample in response to the electromagnetic radiation to isolate a predetermined wavelength of radiation from the sample; and detecting the modulated wavelengths with a detector.

Another aspect of the disclosure is directed to a system for detecting the spectral characteristics of a sample. The system comprises a multiplicity of modulated discrete light sources for emitting electromagnetic radiation; a first filter in communication with the multiplicity of discrete light sources; a detector for detecting an emitted signal from a sample; and a second filter for isolating the emitted signal prior to being detected by the detector.

A kit for detecting the spectral characteristics of a sample is also provided. The kit includes, for example, a multiplicity of modulated discrete light sources in communication with a filter for exciting a sample with electromagnetic radiation of different wavelengths and a detector in communication with a filter for isolating a detected signal from the sample.

Yet another aspect of the disclosure is directed to Raman spectroscopy devices. The devices comprise: a multiplicity of discrete light sources at a first location adapted and configured to apply an electromagnetic radiation to a target sample; a filter positioned at a second location different than the first location, the filter adapted to isolate a predetermined wavelength emitted by the target sample; and a detector for detecting the isolated wavelength. A multiplicity of modulators adapted to modulate a series of individual wavelengths can be used. In some configurations at least one modulator is a Michelson interferometer and/or a current modulator. One or more lenses can be provided that are positioned between the discrete light sources and the target sample. The lens can be adapted and configured to focus the electromagnetic radiation onto the sample. Additionally, the lens can be positioned between the sample and the second location; suitable lenses include collection lenses. Additionally, the second location filter can be a narrow bandpass filter. In some configurations, the second location filter is adapted and configured to filter out radiation within a bandpass of input radiation. The components of the devices can be in a single housing or more than one housing that is configured to engage or communicate with a housing containing other components. A power source which may be removeable may also be provided.

Another aspect of the disclosure is directed to a method for detecting one or more spectral characteristics of a sample. The method comprises the steps of: emitting electromagnetic radiation from one or more discrete light sources; exciting a sample with a series of individual wavelengths of electromagnetic radiation; filtering a signal emitted by the sample in response to the electromagnetic radiation to isolate a predetermined shifted wavelength of radiation from the sample; and detecting the modulated shifted wavelength with a detector. Additional steps include, modulating the series of individual wavelengths with an interferometer, which can be achieved using at least one of a Michelson interferometer and a current modulator. Additionally, in some aspects, the filtering step can be performed in response to a signal emitted by the sample is a narrow bandpass filter.

Yet another aspect of the disclosure is directed to a system for detecting a spectral characteristics of a sample. The system comprises: a multiplicity of modulated discrete light sources for emitting electromagnetic radiation; a detector for detecting an emitted signal from a sample; and a filter for isolating the signal wherein the signal is isolated prior to being detected by the detector. An interferometer adapted to modulate the series of individual wavelengths can also be provided. Suitable interferometers include Michelson interferometers and current modulators. One or more lenses can be provided that are positioned between the discrete light sources and target sample. The lenses can further be adapted and configured to focus the electromagnetic radiation onto the sample. Additionally, a lens can be provided that is positioned between the sample and the filter. Suitable lenses include a collection lens. Filters useful in the system include narrow bandpass filters. In some configurations, the filter is adapted and configured to filter out radiation within a bandpass of input radiation. The components of the devices can be in a single housing or more than one housing that is configured to engage or communicate with a housing containing other components. A power source which may be removeable may also be provided.

Still other aspects of the disclosure are directed to networked apparatuses. The networked apparatuses comprise: a memory; a processor; a communicator; a display; and a system for detecting a spectral characteristic of a sample comprising a multiplicity of discrete light sources at a first location adapted and configured to apply an electromagnetic radiation to a target sample, a filter positioned at a second location different than the first location, the filter adapted to isolate a predetermined wavelength emitted by the target sample; and a detector for detecting the isolated wavelength.

In yet another aspect of the disclosure, a communication system is provided. The communication system comprises: a system for detecting a spectral characteristic of a sample comprising a multiplicity of discrete light sources at a first location adapted and configured to apply an electromagnetic radiation to a target sample, a filter positioned at a second location different than the first location, the filter adapted to isolate a predetermined wavelength emitted by the target sample; and a detector for detecting the isolated wavelength; a server computer system; a measurement module on the server computer system for permitting the transmission of a measurement from a system for detecting spectral characteristics or measurements over a network; at least one of an API engine connected to at least one of the system for detecting spectral characteristics or measurements and the device for detecting spectral characteristics or measurements to create an message about the measurement and transmit the message over an API integrated network to a recipient having a predetermined recipient user name, an SMS engine connected to at least one of the system for detecting spectral characteristics or measurements and the device for detecting spectral characteristics or measurements to create an SMS message about the measurement and transmit the SMS message over a network to a recipient device having a predetermined measurement recipient telephone number, and an email engine connected to at least one of the system for detecting spectral characteristics or measurements and the device for detecting spectral characteristics or measurements to create an email message about the measurement and transmit the email message over the network to a recipient email having a predetermined recipient email address. The measurement module, for example, can be configured to receive information detected by one or more Raman spectroscopy devices associated with the system. A storing module can also be provided on the server computer system for storing the measurement or Raman spectroscopy device measurement data on the system for detecting spectral characteristics or measurements server database. In some configurations at least one of the system for detecting spectral characteristics or measurements and the device for detecting spectral characteristics or measurements is connectable to the server computer system over at least one of a mobile phone network and an Internet network, and a browser on the measurement recipient electronic device is used to retrieve an interface on the server computer system. A plurality of email addresses can be held in a system for detecting spectral characteristics or measurements database and fewer than all the email addresses are individually selectable from the diagnostic host computer system, the email message being transmitted to at least one recipient email having at least one selected email address. At least one of the system for detecting spectral characteristics or measurements and the device for detecting spectral characteristics or measurements is connectable to the server computer system over the Internet, and a browser on the measurement recipient electronic device is used to retrieve an interface on the server computer system. Additionally, plurality of user names are held in the system for detecting spectral characteristics or measurements database and fewer than all the user names are individually selectable from the diagnostic host computer system, the message being transmitted to at least one measurement recipient user name via an API. The measurement (or Raman spectroscopy device measurement data) recipient electronic device is connectable to the server computer system over the Internet, and a browser on the measurement recipient electronic device is used to retrieve an interface on the server computer system. The measurement recipient electronic device is connected to the server computer system over a cellular phone network, such as in situations where the electronic device is a mobile device. In some configurations, an interface on the server computer system, the interface being retrievable by an application on the mobile device. Moreover, the SMS measurement can be configured such that it is received by a message application on the mobile device. A plurality of SMS measurements are received for the measurement, each by a respective message application on a respective recipient mobile device. In some cases at least one SMS engine receives an SMS response over the cellular phone SMS network from the measurement recipient mobile device and stores an SMS response on the server computer system. Measurement recipient phone number ID can also be transmitted with the SMS measurement to the SMS engine and is used by the server computer system to associate the SMS measurement with the SMS response. In some cases the server computer system is connectable over a cellular phone network to receive a response from the measurement recipient mobile device. The SMS measurement can also includes a URL that is selectable at the measurement recipient mobile device to respond from the measurement recipient mobile device to the server computer system, the server computer system utilizing the URL to associate the response with the SMS measurement. The communication system can further be adapted to comprise: a downloadable application residing on the measurement recipient mobile device, the downloadable application transmitting the response and a measurement recipient phone number ID over the cellular phone network to the server computer system, the server computer system utilizing the measurement recipient phone number ID to associate the response with the SMS measurement, a transmissions module that transmits the measurement over a network other than the cellular phone SMS network to a measurement recipient user computer system, in parallel with the measurement that is sent over the cellular phone SMS network, and/or a downloadable application residing on the measurement recipient host computer, the downloadable application transmitting a response and a measurement recipient phone number ID over the cellular phone network to the server computer system, the server computer system utilizing the measurement recipient phone number ID to associate the response with the SMS measurement.

Yet another aspect of the disclosure is directed to a kit for detecting the spectral characteristics or measurements of a sample. Suitable kits comprise: a multiplicity of modulated discrete light sources in communication with a filter for exciting a sample with electromagnetic radiation of different wavelengths; and a detector in communication with a filter for isolating a detected signal form the sample.

### INCORPORATION BY REFERENCE

All publications, patents and patent applications mentioned in this specification are herein incorporated by reference to the same extent as if each individual publication, patent or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is an illustration of a Raman spectroscopy system with a multiplicity of modulated discrete light sources;

FIG. 2 is a flow chart illustrating methods of using a Raman spectroscopy device;

FIG. 3A is a block diagram showing a representative example of a logic device through which dynamic a modular and scalable system can be achieved; and FIG. 3B is a block diagram showing the cooperation of exemplary components of a system suitable for use in a system where dynamic data analysis and modeling is achieved.

### DETAILED DESCRIPTION OF THE INVENTION

The invention described here could be thought of as a Raman spectrometer in reverse. A multiplicity of source wavelengths are modulated or encoded prior to impinging upon a sample. This light is scattered by the sample and a small portion of it is Raman shifted. This Raman shifted light contains vibrational spectroscopic information. The modulated and shifted light is then detected through a narrow bandpass filter. The narrow filter is necessary to allow the input light to be unscrambled and reassembled into a set of Raman wavelengths. Because each input wavelength is encoded or modulated, the pattern of modulation indicates from which wavelength bin the light arose. Typically, the input light is modulated by modulating each discrete light source at a different modulation frequency for instance in a sinusoidal modulation pattern. The time series detected at the detector is thereby related to the Raman shift spectrum through the Fourier transform. The total energy is therefore spread over a wavelength range instead of as a single wavelength of energy for the electromagnetic energy source. The total power can remain the same, as the signal to noise ratio (SNR) of the measurement will depend on the total power within the band. For example, Raman lasers often reach powers of several hundred milliwatts which can have detrimental effects on a sample thereby making the use of Raman lasers unsuitable for applications where specimen integrity is important. The spectroscopy apparatus described herein uses a total power of a few hundred milliwatts over the source wavelength region used.

### I. RAMAN SPECTROSCOPY DEVICES

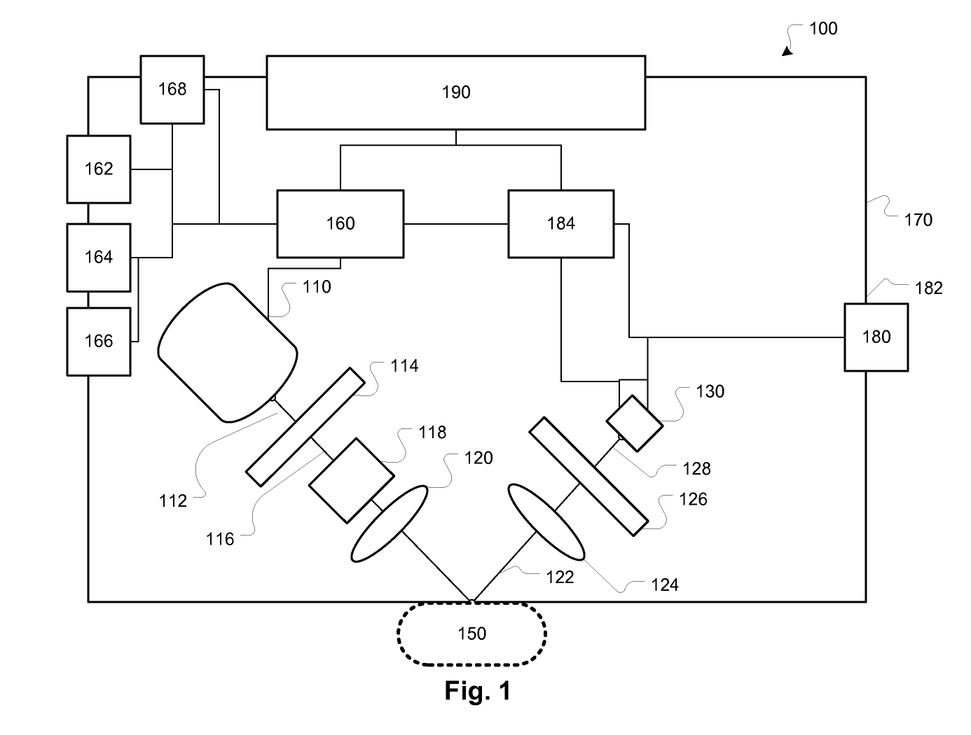

In the present invention, a multiplicity of discrete light sources is used as a source for Raman spectroscopy. FIG. 1 illustrates a Raman spectroscopy device 100 wherein an excitation source is a multiplicity of discrete light sources 110. The multiplicity of discrete light sources 110 can be configured to emit electromagnetic radiation 112 over a range of ten to several hundred nanometers. This light 116 is modulated into a series of wavelength-specific cosine waves by an interferometer, such as the Michelson interferometer 118 shown in FIG. 1 or a current modulator. Alternatively, the sources may be self modulated.

The device can be configured such that it is contained within a suitable housing 170. In another configuration, the components can be configured such that the components function as a housing. In still other configurations, the components are modularizable such that one or more components can be positioned within a housing that is in communication with a second housing containing one or more other components.

Additionally, the devices can be provided with a central processing unit (CPU) 160 adapted and configured to control the operation of the device and associated components of the device, one or more displays 164 (such as liquid crystal display (LCD)) to provide immediate visual feedback of the data reading to a user, audio capability (such as a speaker) 162 to enable the results to be provided audibly, one or more memory devices 180 (e.g., read only memory to control operation and write memory to store data to enable multiple data results to be stored on the device), a data port 182 (such as a PCMCIA port or USB port) to enable retrieval of data, wireless data transmission capability to enable wireless transmission of data to a central system, on/off button(s) 168 to allow user activation of the device, and control buttons 166 to allow interface with, for example, the speaker and display.

Where the device is part of a system monitoring the measurements taken by the device (such as a communication network discussed more fully below) or is configured to store data for later retrieval, a system clock 184 can be provided which associates a date/time stamp with a data collection from one or more detectors 130.

The device can be powered by any suitable power source 190, including, for example, a removeable battery or a plug adapted to access an AC or DC power source.

Moreover, the components can be incorporated into, for example, a diagnostic device or system that is adapted and configured to perform diagnostic tests on a sample. Suitable devices include, for example, non-invasive glucose measuring devices, industrial biodiesel production reactors and fermentation bioreactors.

A lens 120 then focuses the electromagnetic radiation onto the sample 150 for high efficiency. When the electromagnetic radiation interacts with the sample 150, the electromagnetic radiation is then scattered due to the properties of a sample. The scattered radiation 122 is collected by one or more collection lenses 124. The collected radiation 124 then passes through one or more narrow bandpass (NBP) filters 126. The wavelength of the NBP filter 126 is selected so that it filters out the radiation that is within the bandpass of the input radiation. Having passed through the NBP filter 126, the electromagnetic radiation 128 that arrives at the detector 130 is of the same narrow wavelength and contains the modulation frequencies imparted by the Michelson interferometer or by the self-modulation of the light sources. The Raman intensities for each source of the electromagnetic radiation 128 arriving at the detector 130 are recovered by taking the Fourier transform of the signal arriving at the detector.

Although electromagnetic radiation of any wavelength region could be used, typically wavelengths in the green or red region of the spectrum are used. Red wavelengths usually considered ideal for biological applications, for two reasons. First, red is within the so-called “therapeutic window” which is a region of the spectrum that transmits well through human tissue. The therapeutic window is often stated to be from 600 to 900 nanometers. A narrow bandpass filter, is placed in front of the detector. The bandpass is just beyond the emitting region of any of the sources. For Stokes Raman, the narrow detector filter is to the longer wavelength (lower energy) side of the source region.

The multiplicity of modulated discrete light sources is typically a collection of discrete narrow band laser light sources. The bandwidth of the collection of sources will determine the range of analysis for the measurement, so a sufficient number of discrete sources are used in order to measure at all of the important spectral features in the system.

The disclosure describes the use of filters to filter the electromagnetic radiation. Typically, commercially available filters are used, however custom filters maybe be employed as well. The spectroscopy system could also use all custom filters. In one aspect of the devices, three different Raman shift wavelengths can be measured using three laser sources. The Raman shift wavelengths in this example are at 1080, 1118 and 1141 wave numbers (cm⁻¹). In order to measure these three Raman shift wavelengths simultaneously, three lasers at three different excitation wavelengths are used. These lasers are modulated at three different frequencies in a sinusoidal pattern. A single detector with a narrow bandpass filter in front of it is also used. The wavelength of transmission of the narrow bandpass filter and the wavelengths of the three lasers are chosen such that the bandpass filter will pass the appropriate Raman shift information to the detector. The bandpass wavelength must be either longer (Stokes mode) or shorter (anti-Stokes mode) in wavelength than the entire collection of light sources. Wavelengths are also chosen to be in a region where excellent transmission through the sample is possible. For human tissue, this region is generally between 600 and 900 nm. In this example, a narrow bandpass filter in front of the detector at 680 nm, which is equivalent to 14705 cm−1. To measure the aforementioned three Raman shifts, excitation lasers at 14705+1080, and 14705+1118, and 14705+1141 cm−1, or 15785, 15823, and 15846 cm−1, respectively, are suitable for these purposes. Converting to wavelength gives our laser wavelengths of 633.51, 631.99 and 631.07 nm respectively. These three lasers each give rise to a full Raman shift spectrum, but only one specific shift of interest falls at the wavelength of the narrow filter in front of the single detector. All of the light hitting the single detector is of a single narrow wavelength which allows for a well tuned electronics system for detection. Each of the light sources provides its wavelength information at a unique modulation frequency, which makes it possible to determine which source the detected energy emanated from.

Although filters are typically used to modulate the excitation energy, the electromagnetic energy can be modulated by other suitable means for modulating the electromagnetic energy. Each wavelength simply needs to be encoded in a manner that can eventually be decoded. For example, modulated lasers are one solution. A spatial light modulator is another. Lasers are compelling because they are cheap and easy to modulate. Detector size because less important for the silicon detector region; whereas detector size would be more relevant the NIR range. Laser arrays could launch light into multiple fibers (plastic, cheap). Raman shifted scatter would be collected with other fibers and directed to a big, cheap silicon detector. The sensor area at the tissue could be large, averaging out tissue structure variations.

In some cases, single detectors are used. In other cases, where useful, multiple detectors can be used. These detectors can be part of a detector array, such as a charge coupled device (CCD) device. A linear variable filter can be placed in front of this detector array. In this manner, each pixel of the detector can be configured to receive only a narrow bandpass of modulated light. This multi-detector instrument functions like a whole series of single detector instruments, where each detector defines a new shift center. The information received at this series of detectors is therefore practically redundant. This redundant spectral information can be used to improve the SNR of the resulting measurement. The small difference in the signals seen at these detectors could be very useful. Consider a vibrational absorption band in a specimen at a given wavelength of Raman shift. In each detector channel, this vibrational band is produced by a different source wavelength. Therefore any difference in how each channel senses this band is related to not only the band itself, but also to any non-Raman effects such as scatter and fluorescence. By analyzing the differences in the appearance of an absorption band between detectors, any contribution from fluorescence or instrumental defects can be inferred and ultimately removed from the result.

### II. METHODS OF TESTING A TARGET SAMPLE

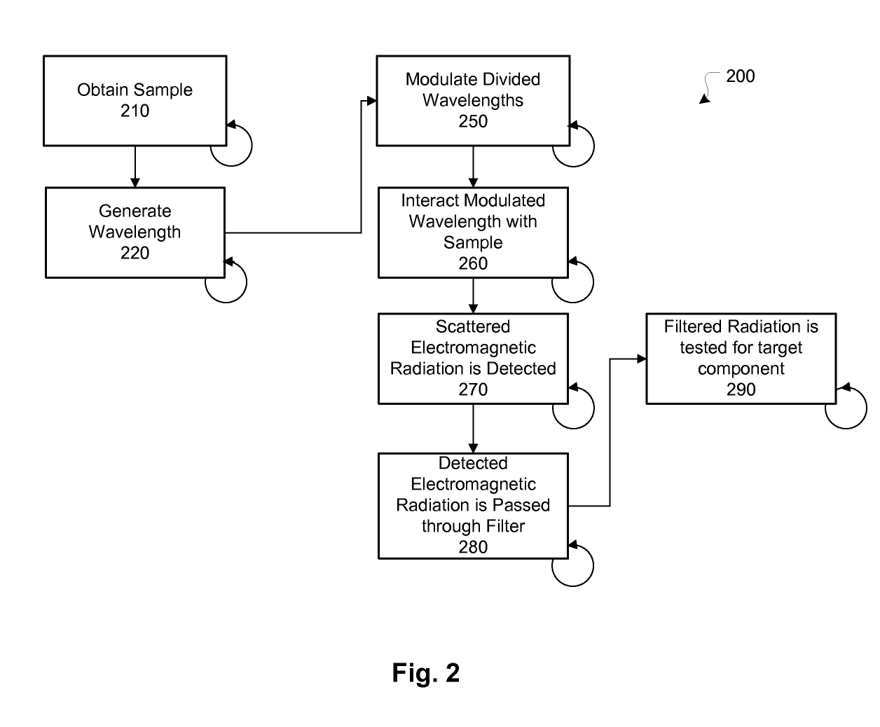

As shown in the flow chart of FIG. 2, a method is provided for testing a target sample for a tested for component 200. Initially, a sample is obtained from a target source 210. A laser is then used to excite the sample with a generated wavelength 220 that is useful in determining the presence of a tested for component in the samples. The energy from the laser generated wavelength The different energy wavelengths are then modulated 250 with a Michelson interferometer or by varying the current on the lasers. The energy then interacts with one or more samples 260 on, for example, a sample plate. The electromagnetic radiation is then scattered by the sample and detected 270 by the detector after having passed through a second filter 280 for isolating the wavelength range indicating the presence of a tested for component 290. If the tested for component is present in the sample, the wavelength indicating the presence of the tested for component will be present. If no tested for component is present, then the wavelength corresponding to the tested for component will not be present. If the tested for component is present, the wavelength corresponding to the presence of the tested for component is then isolated and modulated and then detected by the detector. One or more of each of these steps can be performed one or more times as is desirable under a particular testing protocol.

### III. RAMAN SPECTROSCOPY DEVICES AND COMMUNICATION NETWORKS

As will be appreciated by those skilled in the art, modular and scalable system employing the Raman spectroscopy devices discussed above can be provided which are comprised of a controller and more than Raman spectroscopy devices. Controller communicates with each Raman spectroscopy device over a communication media. Communication media may be a wired point-to-point or multi-drop configuration. Examples of wired communication media include Ethernet, USB, and RS-232. Alternatively communication media may be wireless including radio frequency (RF) and optical. The spectroscopy device may have one or more slots for fluid processing devices. Networked devices can be particularly useful in some situations. For example, networked devices that provide blood glucose monitoring results to a care provider (such as a doctor) can facilitate background analysis of compliance of a diabetic with diet, medication and insulin regimes which could then trigger earlier intervention by a healthcare provider when results begin trending in a clinically undesirable direction. Additionally, automatic messages in response to sample measurements can be generated to either the patient monitoring their glucose level and/or to the care provider. In some instances, automatic messages may be generated by the system to either encourage behavior (e.g., a text message or email indicating a patient is on track) or discourage behavior (e.g., a text message or email indicating that sugars are trending upward). Other automated messages could be either email or text messages providing pointers and tips for managing blood sugar. The networked communication system therefore enables background health monitoring and early intervention which can be achieved at a low cost with the least burden to health care practitioners.

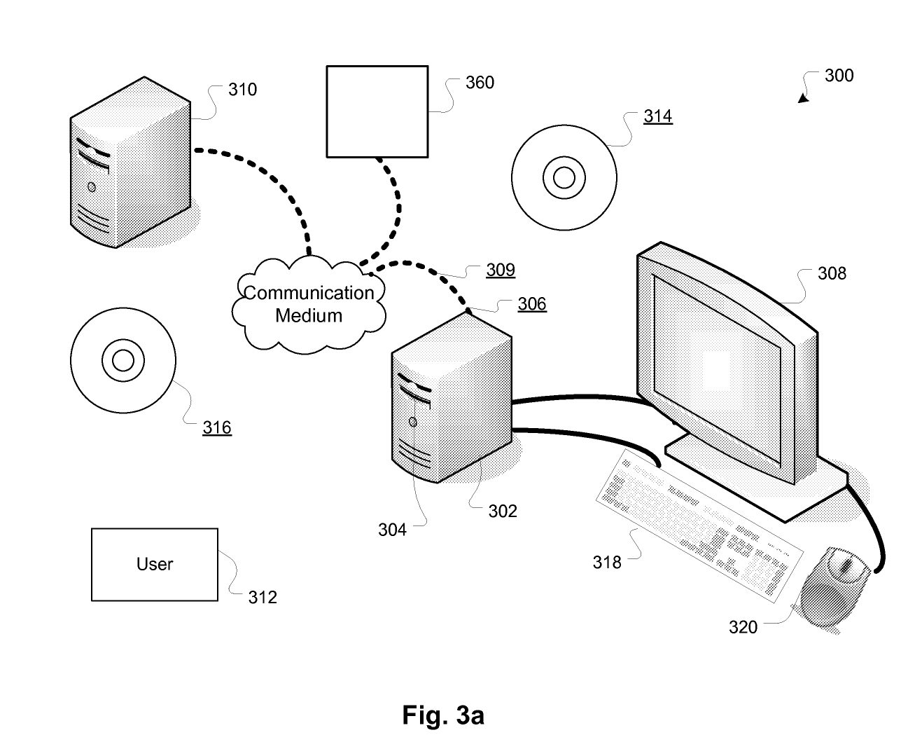

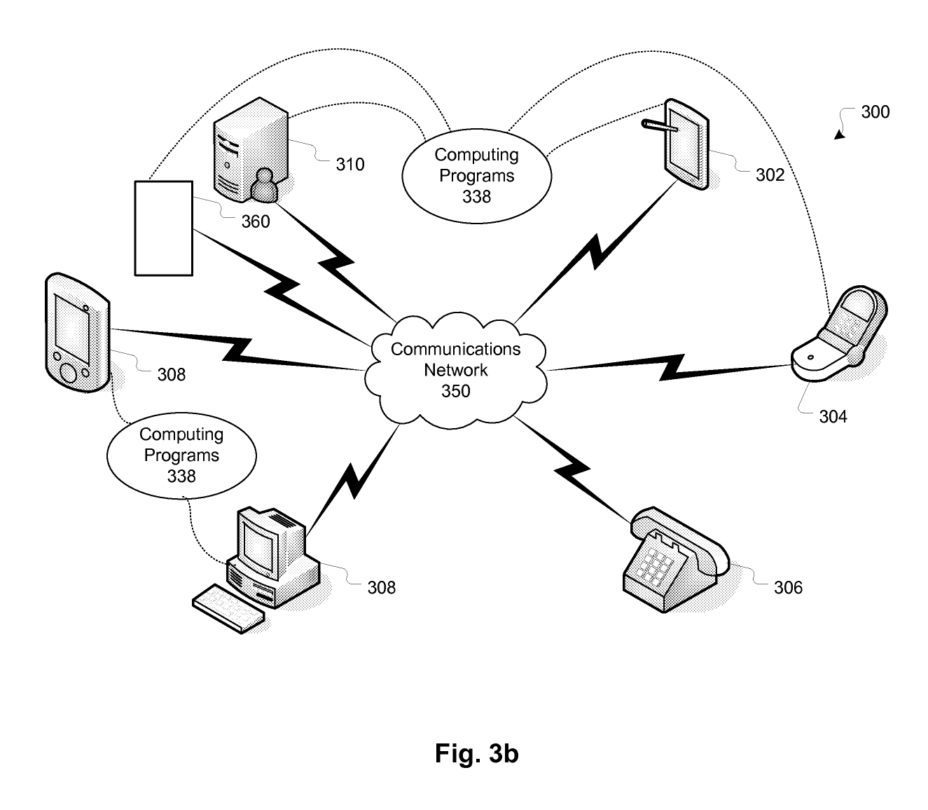

To further appreciate the networked configurations of multiple Raman spectroscopy device in a communication network, FIG. 3A is a block diagram showing a representative example logic device through which a browser can be accessed to control and/or communication with Raman spectroscopy devices and/or diagnostic devices as described above. A computer system (or digital device) 300, which may be understood as a logic apparatus adapted and configured to read instructions from media 314 and/or network port 306, is connectable to a server 310, and has a fixed media 316. The computer system 300 can also be connected to the Internet or an intranet. The system includes central processing unit (CPU) 302, disk drives 304, optional input devices, illustrated as keyboard 318 and/or mouse 320 and optional monitor 308. Data communication can be achieved through, for example, communication medium 309 to a server 310 at a local or a remote location. The communication medium 309 can include any suitable means of transmitting and/or receiving data. For example, the communication medium can be a network connection, a wireless connection, or an internet connection. It is envisioned that data relating to the use, operation or function of one or more Raman spectroscopy devices (shown for purposes of illustration here as 360) can be transmitted over such networks or connections. The computer system can be adapted to communicate with a user (users include healthcare providers, physicians, lab technicians, nurses, nurse practitioners, patients, and any other person or entity which would have access to information generated by the system) and/or a device used by a user. The computer system is adaptable to communicate with other computers over the Internet, or with computers via a server. Moreover the system is configurable to activate one or more devices associated with the network (e.g., Raman spectroscopy device) and to communicate status and/or results of tests performed by the Raman spectroscopy device.

As is well understood by those skilled in the art, the Internet is a worldwide network of computer networks. Today, the Internet is a public and self-sustaining network that is available to many millions of users. The Internet uses a set of communication protocols called TCP/IP (i.e., Transmission Control Protocol/Internet Protocol) to connect hosts. The Internet has a communications infrastructure known as the Internet backbone. Access to the Internet backbone is largely controlled by Internet Service Providers (ISPs) that resell access to corporations and individuals.

The Internet Protocol (IP) enables data to be sent from one device (e.g., a phone, a Personal Digital Assistant (PDA), a computer, etc.) to another device on a network. There are a variety of versions of IP today, including, e.g., IPv4, IPv6, etc. Other IPs are no doubt available and will continue to become available in the future, any of which can, in a communication network adapted and configured to employ or communicate with one or more Raman spectroscopy devices, be used without departing from the scope of the invention. Each host device on the network has at least one IP address that is its own unique identifier and acts as a connectionless protocol. The connection between end points during a communication is not continuous. When a user sends or receives data or messages, the data or messages are divided into components known as packets. Every packet is treated as an independent unit of data and routed to its final destination—but not necessarily via the same path.

The Open System Interconnection (OSI) model was established to standardize transmission between points over the Internet or other networks. The OSI model separates the communications processes between two points in a network into seven stacked layers, with each layer adding its own set of functions. Each device handles a message so that there is a downward flow through each layer at a sending end point and an upward flow through the layers at a receiving end point. The programming and/or hardware that provides the seven layers of function is typically a combination of device operating systems, application software, TCP/IP and/or other transport and network protocols, and other software and hardware.

Typically, the top four layers are used when a message passes from or to a user and the bottom three layers are used when a message passes through a device (e.g., an IP host device). An IP host is any device on the network that is capable of transmitting and receiving IP packets, such as a server, a router or a workstation. Messages destined for some other host are not passed up to the upper layers but are forwarded to the other host. The layers of the OSI model are listed below. Layer 7 (i.e., the application layer) is a layer at which, e.g., communication partners are identified, quality of service is identified, user authentication and privacy are considered, constraints on data syntax are identified, etc. Layer 6 (i.e., the presentation layer) is a layer that, e.g., converts incoming and outgoing data from one presentation format to another, etc. Layer 5 (i.e., the session layer) is a layer that, e.g., sets up, coordinates, and terminates conversations, exchanges and dialogs between the applications, etc. Layer-4 (i.e., the transport layer) is a layer that, e.g., manages end-to-end control and error-checking, etc. Layer-3 (i.e., the network layer) is a layer that, e.g., handles routing and forwarding, etc. Layer-2 (i.e., the data-link layer) is a layer that, e.g., provides synchronization for the physical level, does bit-stuffing and furnishes transmission protocol knowledge and management, etc. The Institute of Electrical and Electronics Engineers (IEEE) sub-divides the data-link layer into two further sub-layers, the MAC (Media Access Control) layer that controls the data transfer to and from the physical layer and the LLC (Logical Link Control) layer that interfaces with the network layer and interprets commands and performs error recovery. Layer 1 (i.e., the physical layer) is a layer that, e.g., conveys the bit stream through the network at the physical level. The IEEE sub-divides the physical layer into the PLCP (Physical Layer Convergence Procedure) sub-layer and the PMD (Physical Medium Dependent) sub-layer.

Wireless networks can incorporate a variety of types of mobile devices, such as, e.g., cellular and wireless telephones, PCs (personal computers), laptop computers, wearable computers, cordless phones, pagers, headsets, printers, PDAs, etc. and suitable for use in a system or communication network that includes one or more Raman spectroscopy devices. For example, mobile devices may include digital systems to secure fast wireless transmissions of voice and/or data. Typical mobile devices include some or all of the following components: a transceiver (for example a transmitter and a receiver, including a single chip transceiver with an integrated transmitter, receiver and, if desired, other functions); an antenna; a processor; display; one or more audio transducers (for example, a speaker or a microphone as in devices for audio communications); electromagnetic data storage (such as ROM, RAM, digital data storage, etc., such as in devices where data processing is provided); memory; flash memory; and/or a full chip set or integrated circuit; interfaces (such as universal serial bus (USB), coder-decoder (CODEC), universal asynchronous receiver-transmitter (UART), phase-change memory (PCM), etc.). Other components can be provided without departing from the scope of the invention.

Wireless LANs (WLANs) in which a mobile user can connect to a local area network (LAN) through a wireless connection may be employed for wireless communications between one or more Raman spectroscopy devices. Wireless communications can include communications that propagate via electromagnetic waves, such as light, infrared, radio, and microwave. There are a variety of WLAN standards that currently exist, such as Bluetooth®, IEEE 802.11, and the obsolete HomeRF.

By way of example, Bluetooth products may be used to provide links between mobile computers, mobile phones, portable handheld devices, personal digital assistants (PDAs), and other mobile devices and connectivity to the Internet. Bluetooth is a computing and telecommunications industry specification that details how mobile devices can easily interconnect with each other and with non-mobile devices using a short-range wireless connection. Bluetooth creates a digital wireless protocol to address end-user problems arising from the proliferation of various mobile devices that need to keep data synchronized and consistent from one device to another, thereby allowing equipment from different vendors to work seamlessly together.

An IEEE standard, IEEE 802.11, specifies technologies for wireless LANs and devices. Using 802.11, wireless networking may be accomplished with each single base station supporting several devices. In some examples, devices may come pre-equipped with wireless hardware or a user may install a separate piece of hardware, such as a card, that may include an antenna. By way of example, devices used in 802.11 typically include three notable elements, whether or not the device is an access point (AP), a mobile station (STA), a bridge, a personal computing memory card International Association (PCMCIA) card (or PC card) or another device: a radio transceiver; an antenna; and a MAC (Media Access Control) layer that controls packet flow between points in a network.

In addition, Multiple Interface Devices (MIDs) may be utilized in some wireless networks. MIDs may contain two independent network interfaces, such as a Bluetooth interface and an 802.11 interface, thus allowing the MID to participate on two separate networks as well as to interface with Bluetooth devices. The MID may have an IP address and a common IP (network) name associated with the IP address.

Wireless network devices may include, but are not limited to Bluetooth devices, WiMAX (Worldwide Interoperability for Microwave Access), Multiple Interface Devices (MIDs), 802.11x devices (IEEE 802.11 devices including, 802.11a, 802.11b and 802.11g devices), HomeRF (Home Radio Frequency) devices, Wi-Fi (Wireless Fidelity) devices, GPRS (General Packet Radio Service) devices, 3 G cellular devices, 2.5 G cellular devices, GSM (Global System for Mobile Communications) devices, EDGE (Enhanced Data for GSM Evolution) devices, TDMA type (Time Division Multiple Access) devices, or CDMA type (Code Division Multiple Access) devices, including CDMA2000. Each network device may contain addresses of varying types including but not limited to an IP address, a Bluetooth Device Address, a Bluetooth Common Name, a Bluetooth IP address, a Bluetooth IP Common Name, an 802.11 IP Address, an 802.11 IP common Name, or an IEEE MAC address.

Wireless networks can also involve methods and protocols found in, Mobile IP (Internet Protocol) systems, in PCS systems, and in other mobile network systems. With respect to Mobile IP, this involves a standard communications protocol created by the Internet Engineering Task Force (IETF). With Mobile IP, mobile device users can move across networks while maintaining their IP Address assigned once. See Request for Comments (RFC) 3344. NB: RFCs are formal documents of the Internet Engineering Task Force (IETF). Mobile IP enhances Internet Protocol (IP) and adds a mechanism to forward Internet traffic to mobile devices when connecting outside their home network. Mobile IP assigns each mobile node a home address on its home network and a care-of-address (CoA) that identifies the current location of the device within a network and its subnets. When a device is moved to a different network, it receives a new care-of address. A mobility agent on the home network can associate each home address with its care-of address. The mobile node can send the home agent a binding update each time it changes its care-of address using Internet Control Message Protocol (ICMP).

In basic IP routing (e.g., outside mobile IP), routing mechanisms rely on the assumptions that each network node always has a constant attachment point to the Internet and that each node's IP address identifies the network link it is attached to. Nodes include a connection point, which can include a redistribution point or an end point for data transmissions, and which can recognize, process and/or forward communications to other nodes. For example, Internet routers can look at an IP address prefix or the like identifying a device's network. Then, at a network level, routers can look at a set of bits identifying a particular subnet. Then, at a subnet level, routers can look at a set of bits identifying a particular device. With typical mobile IP communications, if a user disconnects a mobile device from the Internet and tries to reconnect it at a new subnet, then the device has to be reconfigured with a new IP address, a proper netmask and a default router. Otherwise, routing protocols would not be able to deliver the packets properly.

Computing system 300, described above, can be deployed as part of a computer network that includes one or more Raman spectroscopy devices. In general, the above description for computing environments applies to both server computers and client computers deployed in a network environment. FIG. 3B illustrates an exemplary illustrative networked computing environment 300, with a server in communication with client computers via a communications network 350. As shown in FIG. 3B, server 310 may be interconnected via a communications network 350 (which may be either of, or a combination of a fixed-wire or wireless LAN, WAN, intranet, extranet, peer-to-peer network, virtual private network, the Internet, or other communications network) with a number of client computing environments such as tablet personal computer 302, mobile telephone 304, telephone 306, personal computer 302, and personal digital assistant 308. In a network environment in which the communications network 350 is the Internet, for example, server 310 can be dedicated computing environment servers operable to process and communicate data to and from client computing environments via any of a number of known protocols, such as, hypertext transfer protocol (HTTP), file transfer protocol (FTP), simple object access protocol (SOAP), or wireless application protocol (WAP). Other wireless protocols can be used without departing from the scope of the invention, including, for example Wireless Markup Language (WML), DoCoMo i-mode (used, for example, in Japan) and XHTML Basic. Additionally, networked computing environment 300 can utilize various data security protocols such as secured socket layer (SSL) or pretty good privacy (PGP). Each client computing environment can be equipped with operating system 338 operable to support one or more computing applications, such as a web browser (not shown), or other graphical user interface (not shown), or a mobile desktop environment (not shown) to gain access to server computing environment 300.

In operation, a user (not shown) may interact with a computing application running on a client computing environment to obtain desired data and/or computing applications. The data and/or computing applications may be stored on server computing environment 300 and communicated to cooperating users through client computing environments over exemplary communications network 350. A participating user may request access to specific data and applications housed in whole or in part on server computing environment 300. These data may be communicated between client computing environments and server computing environments for processing and storage. Server computing environment 300 may host computing applications, processes and applets for the generation, authentication, encryption, and communication data and applications and may cooperate with other server computing environments (not shown), third party service providers (not shown), network attached storage (NAS) and storage area networks (SAN) to realize application/data transactions.

### IV. KITS

Bundling all devices, tools, components, materials, and accessories needed to use a Raman spectroscopic device to test a sample into a kit may enhance the usability and convenience of the devices. Kits configured may be single-use or reusable, or may incorporate some disposable single-use elements and some reusable elements. The kit includes, for example, a multiplicity of modulated discrete light sources in communication with a filter for exciting a sample with electromagnetic radiation of different wavelengths and a detector in communication with a filter for isolating a detected signal from the sample. The kit may contain, but is not limited to, the following: scissors; scalpels; clips. Additional components can include, for example, alcohol swabs used to clean a surface where a measurement will be taken, prep material to be applied toward a surface where a measurement will be taken to enhance transmission of electromagnetic radiation and the like. The kit may be supplied in a tray, which organizes and retains all items so that they can be quickly identified and used.

### V. EXAMPLES

### Example 1

### Detecting Blood Glucose Levels in Patients Using Multiplicity of Modulated Discrete Light Source Raman Spectroscopy

The invention described herein can be used to determine blood glucose levels in a series of samples. Samples can be drawn from patients suspected of having diabetes. The blood drawn from the patients is then isolated and contained in different wells in a sample plate. The sample plate placed in the Broadband spectroscopy apparatus. An LED is then used to excite the blood samples with a wavelength that is useful in determining the presence of glucose in the samples. The different energy wavelengths are then modulated with a Michelson interferometer or self-modulated. The energy then interacts with each sample on the sample plate. The electromagnetic radiation is then scattered by the sample and detected by the detector after having passed through a second filter for isolating the wavelength range indicating the presence of glucose. If glucose is present in the sample, the wavelength indicating the presence of glucose will be present. If no glucose is present, then the wavelength corresponding to glucose will not be present. If glucose is present, the wavelength corresponding to the presence of glucose is then isolated and modulated and then detected by the detector.

Where the samples are tested in, for example, a lab environment and the spectroscopy devices are part of a communication network, the results along with patient identifying information can then be communicated electronically via the network to the patient and/or healthcare practitioner.

### Example 2

### In Situ Monitoring of Thickness and Composition of Deposited Films Using Raman Spectroscopy

The invention described herein can be used to monitor film being deposited on a wafer for manufacturing a semiconductor device. The invention described here in can be incorporated used during a deposition process. The series of wavelengths of electromagnetic radiation from the broadbeam light source can be directed during a deposition process to a film being deposited on a wafer. The series of wavelengths of electromagnetic radiation interact with the film as it is deposited on the wafer. The scattered radiation resulting from the interaction between the series of wavelengths and the molecules of deposited film can then be isolated and modulated and detected by the detector to produce a Raman spectrum of deposited film. Once a Raman spectrum indicating that the desired amount of film has been deposited, the deposition process can then be stopped.

Where the films are tested in, for example, a production facility and the spectroscopy devices are part of a communication network, the system can be set-up to alert a quality supervisor via the network of any anomalies in the film deposition process.

### VI. REFERENCES

L. Mandel and E. Wolf, Optical Coherence and Quantum Optics, Cambridge University Press, New York, 1995.
M. Born and E. Wolf, Principles of Optics, Cambridge University Press, 1997.
W. H. Steel, Interferometry, Cambridge University Press, 1967.
A. Girard, Appl. Optics 2, 79 (1963).
J. G. Hirschberg and P. Platz, Appl. Optics 4, 1375.
W. H. Steel, Interferometry, Cambridge University Press, 1967. p. 123.
L. Mandel, Electromagnetic Theory and Antennas, ed. E. C. Jordan, part 2, p. 811, Macmillan, New York (1963).
A. A. Michelson, Light Waves and Their Uses, University of Chicago Press (1902).
W. H. Steel, Interferometry, Cambridge University Press, 1967. p. 54.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A Raman spectroscopy device comprising:
a multiplicity of discrete light sources at a first location adapted and configured to apply an electromagnetic radiation to a target sample;
a filter positioned at a second location different than the first location, the filter adapted to isolate a predetermined wavelength emitted by the target sample; and
a detector for detecting the isolated wavelength.

2. The device of claim 1 further comprising an multiplicity of modulators adapted to modulate a series of individual wavelengths.

3. The device of claim 2 wherein the modulator is at least one of a Michelson interferometer and a current modulator.

4. The device of claim 1 further comprising a lens positioned between the discrete light sources and target sample.

5. The device of claim 4 wherein the lens is adapted and configured to focus the electromagnetic radiation onto the sample.

6. The device of claim 1 further comprising a lens positioned between the sample and the second location filter.

7. The device of claim 6 wherein the lens is a collection lens.

8. The device of claim 1 wherein the second location filter is a narrow bandpass filter.

9. The device of claim 1 wherein the second location filter is adapted and configured to filter out radiation within a bandpass of input radiation.

10. The device of claim 1 further comprising a housing.

11. The device of claim 1 further comprising a power source.

12. A method for detecting one or more spectral characteristics of a sample comprising the steps of:
emitting electromagnetic radiation from one or more discrete light sources;
exciting a sample with a series of individual wavelengths of electromagnetic radiation;
filtering a signal emitted by the sample in response to the electromagnetic radiation to isolate a predetermined shifted wavelength of radiation from the sample; and
detecting the modulated shifted wavelength with a detector.

13. The method of claim 12 further comprising the step of modulating the series of individual wavelengths with an interferometer.

14. The method of claim 13 wherein the interferometer is at least one of a Michelson interferometer and a current modulator.

15. The method of claim 12 wherein the filtering step performed in response to a signal emitted by the sample is a narrow bandpass filter.

16. A system for detecting a spectral characteristics of a sample comprising:
a multiplicity of modulated discrete light sources for emitting electromagnetic radiation;
a detector for detecting an emitted signal from a sample; and
a filter for isolating the signal wherein the signal is isolated prior to being detected by the detector.

17. The system of claim 16 further comprising an interferometer adapted to modulate the series of individual wavelengths.

18. The system of claim 17 wherein the interferometer is at least one of a Michelson interferometer and a current modulator.

19. The system of claim 17 further comprising a lens positioned between the discrete light sources and target sample.

20. The system of claim 19 wherein the lens is adapted and configured to focus the electromagnetic radiation onto the sample.

21. The system of claim 17 further comprising a lens positioned between the sample and the filter.

22. The system of claim 21 wherein the lens is a collection lens.

23. The system of claim 17 wherein the filter is a narrow bandpass filter.

24. The system of claim 17 wherein the filter is adapted and configured to filter out radiation within a bandpass of input radiation.

25. The system of claim 17 further comprising a housing.

26. The system of claim 17 further comprising a power source.

27. A networked apparatus comprising:
a memory;
a processor;
a communicator;
a display; and
a system for detecting a spectral characteristic of a sample comprising a multiplicity of discrete light sources at a first location adapted and configured to apply an electromagnetic radiation to a target sample, a filter positioned at a second location different than the first location, the filter adapted to isolate a predetermined wavelength emitted by the target sample; and a detector for detecting the isolated wavelength.

28. A communication system, comprising:
a system for detecting a spectral characteristic of a sample comprising a multiplicity of discrete light sources at a first location adapted and configured to apply an electromagnetic radiation to a target sample, a filter positioned at a second location different than the first location, the filter adapted to isolate a predetermined wavelength emitted by the target sample; and a detector for detecting the isolated wavelength;
a server computer system;
a measurement module on the server computer system for permitting the transmission of a measurement from a system for detecting spectral characteristics over a network;
at least one of an API engine connected to at least one of the system for detecting spectral characteristics and the device for detecting spectral characteristics to create an message about the measurement and transmit the message over an API integrated network to a recipient having a predetermined recipient user name, an SMS engine connected to at least one of the system for detecting spectral characteristics and the device for detecting spectral characteristics to create an SMS message about the measurement and transmit the SMS message over a network to a recipient device having a predetermined measurement recipient telephone number, and an email engine connected to at least one of the system for detecting spectral characteristics and the device for detecting spectral characteristics to create an email message about the measurement and transmit the email message over the network to a recipient email having a predetermined recipient email address.

29. The communication system of claim 28, further comprising a storing module on the server computer system for storing the measurement on the system for detecting spectral characteristics server database.

30. The communications system of claim 29, wherein at least one of the system for detecting spectral characteristics and the device for detecting spectral characteristics is connectable to the server computer system over at least one of a mobile phone network and an Internet network, and a browser on the measurement recipient electronic device is used to retrieve an interface on the server computer system.

31. The communications system of claim 29, wherein a plurality of email addresses are held in a system for detecting spectral characteristics database and fewer than all the email addresses are individually selectable from the diagnostic host computer system, the email message being transmitted to at least one recipient email having at least one selected email address.

32. The communications system of claim 31, wherein at least one of the system for detecting spectral characteristics and the device for detecting spectral characteristics is connectable to the server computer system over the Internet, and a browser on the measurement recipient electronic device is used to retrieve an interface on the server computer system.

33. The communications system of claim 30, wherein a plurality of user names are held in the system for detecting spectral characteristics database and fewer than all the user names are individually selectable from the diagnostic host computer system, the message being transmitted to at least one measurement recipient user name via an API.

34. The communications system of claim 33, wherein the measurement recipient electronic device is connectable to the server computer system over the Internet, and a browser on the measurement recipient electronic device is used to retrieve an interface on the server computer system.

35. The communications system of claim 30, wherein the measurement recipient electronic device is connected to the server computer system over a cellular phone network.

36. The communications system of claim 35, wherein the measurement recipient electronic device is a mobile device.

37. The communications system of claim 36, further comprising: an interface on the server computer system, the interface being retrievable by an application on the mobile device.

38. The communications system of claim 36, wherein the SMS measurement is received by a message application on the mobile device.

39. The communications system of claim 38, wherein a plurality of SMS measurements are received for the measurement, each by a respective message application on a respective recipient mobile device.

40. The communications system of claim 30, wherein the at least one SMS engine receives an SMS response over the cellular phone SMS network from the mobile device and stores an SMS response on the server computer system.

41. The communications system of claim 40, wherein a measurement recipient phone number ID is transmitted with the SMS measurement to the SMS engine and is used by the server computer system to associate the SMS measurement with the SMS response.

42. The communications system of claim 30, wherein the server computer system is connectable over a cellular phone network to receive a response from the measurement recipient mobile device.

43. The communications system of claim 42, wherein the SMS measurement includes a URL that is selectable at the measurement recipient mobile device to respond from the measurement recipient mobile device to the server computer system, the server computer system utilizing the URL to associate the response with the SMS measurement.

44. The communications system of claim 30, further comprising:
a downloadable application residing on the measurement recipient mobile device, the downloadable application transmitting the response and a measurement recipient phone number ID over the cellular phone network to the server computer system, the server computer system utilizing the measurement recipient phone number ID to associate the response with the SMS measurement.

45. The communications system of claim 30, further comprising:
a transmissions module that transmits the measurement over a network other than the cellular phone SMS network to a measurement recipient user computer system, in parallel with the measurement that is sent over the cellular phone SMS network.

46. The communication system of claim 30 further comprising
a downloadable application residing on the measurement recipient host computer, the downloadable application transmitting a response and a measurement recipient phone number ID over the cellular phone network to the server computer system, the server computer system utilizing the measurement recipient phone number ID to associate the response with the SMS measurement.

47. A kit for detecting the spectral characteristics of a sample comprising:
a multiplicity of modulated discrete light sources in communication with a filter for exciting a sample with electromagnetic radiation of different wavelengths; and
a detector in communication with a filter for isolating a detected signal form the sample.
